(19) United States
(12) Patent Application Publication
(10) Pub. No.: US 2016/0314912 A1
(43) Pub. Date: Oct. 27, 2016

(54) COVER ASSEMBLY FOR SWITCH

(71) Applicant: Caterpillar Inc., Peoria, IL (US)

(72) Inventor: Robert M. Stengl, Locust Grove, GA (US)

(73) Assignee: Caterpillar Inc., Peoria, IL (US)

(21) Appl. No.: 15/200,391

(22) Filed: Jul. 1, 2016

(51) Int. Cl. H01H 9/02

(52) U.S. Cl. CPC H01H 9/02

(57) ABSTRACT

A cover for a control switch is disclosed. The cover includes a first member connected to a housing member of the control switch. The first member includes an inner peripheral portion. The cover also includes a second member having an outer peripheral portion attached to the first member for concealing the control switch. The cover includes at least one breakable tab extending between the inner peripheral portion of the first member and the outer peripheral portion of the second member for connecting the first member and the second member. The second member is adapted to be detached from the first member by breaking the at least one breakable tab to access the control switch.

### TECHNICAL FIELD

The present disclosure relates to control switches, and more specifically to a cover assembly for a control switch.

### BACKGROUND

Electrical devices, such as generators, usually include various switches, such as an emergency stop switch. The emergency stop switch is provided for switching-off a generator during emergency situations. Generally, the emergency stop switch is open and therefore, may be susceptible to an unauthorized access. The emergency switch may otherwise be provided with a break-glass type cover assembly to restrict any unauthorized access to the emergency stop switch. However, in order to get access to the emergency stop switch, the break-glass type cover assembly is to be broken. This can be cumbersome and time consuming activity. Further, it is difficult and expensive to retrofit such break-glass type cover assembly on the emergency stop switch.

U.S. Patent Publication Number 2004/0111195, hereinafter referred to as '195 publication, describes a marine telematics system. The invention includes a marine telematics system with a module mounted on a boat as a control panel. The operator module may be mounted on the boat, for example, in the cabin or at the helm, preferably in an easily accessible place. The operator module may include an emergency button which may be used by boaters in case of any sort of emergency that the boaters think they cannot handle alone. In order to avoid accidental depression of the emergency button, the operator module may include a break away cover, which a distressed boater must remove before the emergency button can be pressed. Preferably, the break away cover may be easily broken away by pulling on a pull-tab or any other suitable means.

### SUMMARY OF THE DISCLOSURE

In one aspect of the present disclosure, a cover for a control switch is disclosed. The cover includes a first member connected to a housing member of the control switch. The first member includes an inner peripheral portion. The cover also includes a second member having an outer peripheral portion attached to the first member for concealing the control switch. The cover includes at least one breakable tab extending between the inner peripheral portion of the first member and the outer peripheral portion of the second member for connecting the first member and the second member, The second member is adapted to be detached from the first member by breaking the at least one breakable tab to access the control switch.

In another aspect of the present disclosure, the cover assembly for a control switch is disclosed. The cover assembly includes a cover coupled to a housing member of the control switch. The cover includes a first member connected to a housing member of the control switch. The first member includes an inner peripheral portion. The cover also includes a second member having an outer peripheral portion attached to the first member for concealing the control switch. The cover includes at least one breakable tab extending between the inner peripheral portion of the first member and the outer peripheral portion of the second member for connecting the first member and the second member. The cover assembly also includes a mounting member coupled to the first member and the housing member, The cover assembly includes a tool removably supported on the mounting member. The tool includes at least one engagable portion adapted to selectively engage with the at least one breakable tab. The second member is adapted to detach from the first member by breaking the at least breakable tab using the tool to access the control switch.

Other features and aspects of this disclosure will be apparent from the following description and the accompanying drawings.

### BRIEF DESCRIPTION OF THE DRAWINGS

FIG. 1 is a perspective view of an exemplary power source, according to an embodiment of the present disclosure;

FIG. 2 is a perspective view of a cover assembly having a cover concealing a control switch of the power source of FIG. 1;

FIG. 3 is an exploded view of the cover assembly of FIG. 2;

FIG. 4 is a from view of the cover of the cover assembly;

FIG. 5 is a perspective view of a tool engaged with a first breakable tab of the cover; and

FIG. 6 is a flowchart depicting a method of accessing the control switch concealed by the cover assembly.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

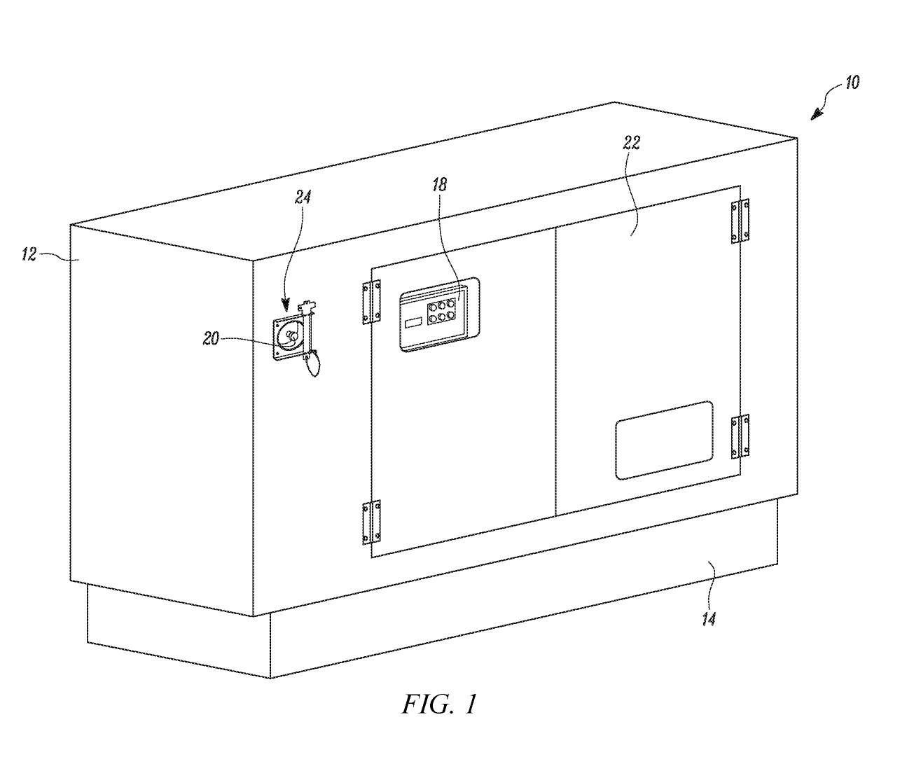

FIG. 1 illustrates a perspective view of an exemplary power source 10, according to an embodiment of the present disclosure. The power source 10 is embodied as a generator set. In an example, the power source 10 may include, but is not limited to, an electric motor and a hydraulic pump. The power source 10 will be referred hereinafter as “The generator set 10”. The generator set 10 supplies electric power to locations where utility power is not available or when backup electric power is required. Specifically, in applications, such as telecommunications, hospitals, and data processing centers, the generator set 10 is permanently installed on a ground surface (not shown) near the respective locations for supplying electric power.

The generator set 10 includes an enclosure 12 supported on a base 14. The enclosure 12 may accommodate an engine (not shown) and a generator (not shown) coupled to the engine for generating electric power. The engine may include a single cylinder or multiple cylinders. Further, the engine may run on fuels, such as diesel, gasoline, natural gas, propane, other known fuel sources, or a combination thereof The generator is coupled to the engine to receive rotary power therefrom. The generator further converts the rotary power into electric power. The generator may be an Alternating Current (AC) generator, a Direct Current (DC) generator, or any other type of generators known in the art.

The generator set 10 further includes a control panel 18 and a control switch 20. The control panel 18 is in electric communication with the engine and the generator. The control panel 18 includes one or more display devices (not shown) for monitoring various inputs and outputs pertaining to operation of the generator set 10. The control panel 18 may also include one or more control members, such as an ON-OFF switch, a voltage/current controller, an engine controller, or any other control member, used for controlling operation of the generator set 10.

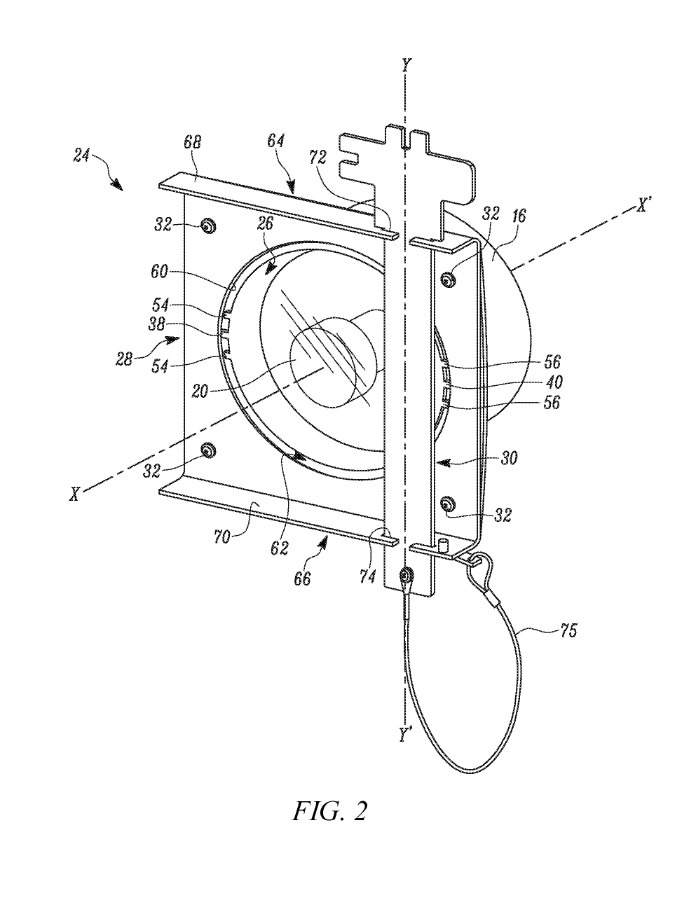

The control switch 20 is provided for switching-off the generator set 10 during emergency situations. The control switch 20 can be accessed by authorized personnel through a doorway 22 of the enclosure 12. The control switch 20 is disposed in a housing member 16 (shown in FIG. 2) enclosed within the enclosure 12 of the generator set 10. As shown in FIG. 1, the control switch 20 is covered by a cover assembly 24, which will be described in detail with reference to FIGS. 2 to 4.

FIG. 2 illustrates a perspective view of the cover assembly 24. The cover assembly 24 is coupled to the housing member 16 of the control switch 20. More specifically, the cover assembly 24 is removably fastened to the housing member 16 of the control switch 20. In an example, the cover assembly 24 may be directly coupled to the enclosure 12 of the generator set 10. The cover assembly 24 conceals the control switch 20 of the generator set 10.

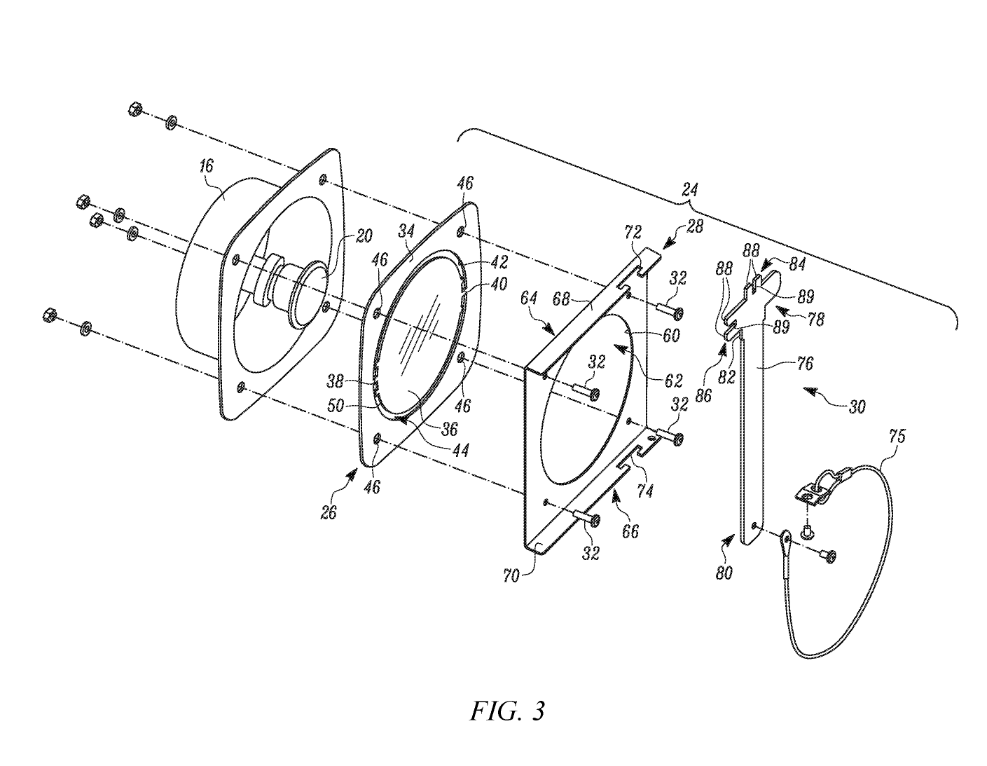

FIG. 3 illustrates an exploded view of the cover assembly 24. Referring to FIG. 2 and FIG. 3, the cover assembly 24 includes a cover 26, a mounting member 28, and a tool 30. The cover 26 is coupled to the housing member 16 of the control switch 20. In an example, the cover 26 may be directly coupled to the enclosure 12 of the generator set 10. More specifically, the cover 26 is removably fastened to the housing member 16 of the control switch 20, via fastening members 32. The fastening members 32 may include, but are not limited to, an anchor bolt, a threaded fastener, a threaded rod, and a screw anchor.

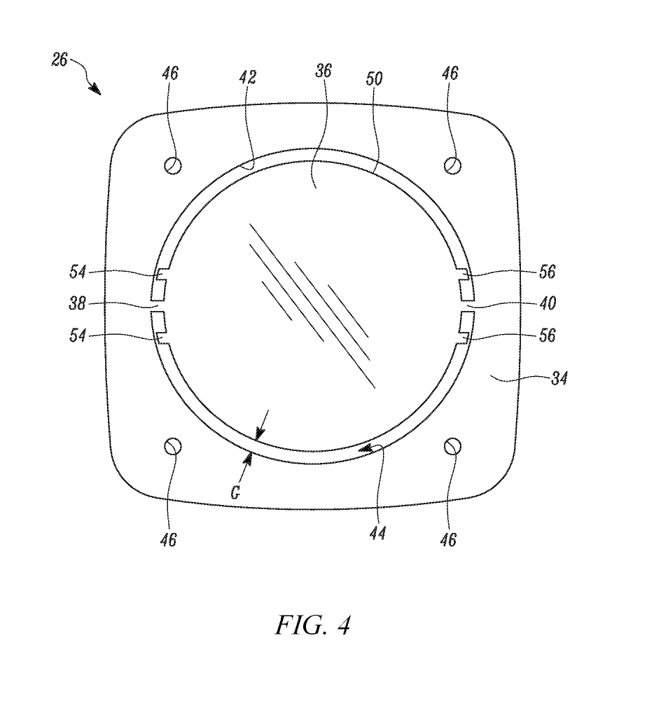

FIG. 4 illustrates a front view of the cover 26 of the cover assembly 24. Referring to FIGS. 2 to 4, the cover 26 includes a first member 34, a second member 36, and a number of breakable tabs, such as a first breakable tab 38 and a second breakable tab 40. The first member 34 of the cover 26 has a rectangular shape. In an example, the first member 34 of the cover 26 may have one of, but is not limited to, a square shape and a circular shape. The first member 34 is made of a transparent material, such as a plastic material or any other breakable transparent material known in the art. The first member 34 includes an inner peripheral portion 42. The inner peripheral portion 42 defines an access opening 44 for the control switch 20. More specifically, the inner peripheral portion 42 defines the access opening 44 for accessing the control switch 20 therethrough. The access opening 44 has a circular profile. In an example, the access opening 44 may have one of, but is not limited to, a rectangular profile and a square profile.

The first member 34 is coupled to the housing member 16 of the control switch 20. More specifically, the first member 34 is fastened to the housing member 16, via the fastening members 32. The first member 34 includes a number of through holes 46 for receiving the fastening members 32 therethrough, and subsequently fastening the first member 34 with the housing member 16 of the control switch 20, The first member 34 is fastened to the housing member 16 such that the access opening 44 of the first member 34 is coaxially positioned to the control switch 20. The first member 34 is attached to the second member 36 of the cover 26.

The second member 36 has a circular shape. In one example, the second member 36 may have a shape similar to that of the access opening 44 of the first member 34. In another example, the second member 36 may have a different shape from the access opening 44 of the first member 34. The second member 36 is made of a transparent material, such as plastic material or any other breakable transparent material know in the art. More specifically, the second member 36 is made of a material similar to that of the first member 34 of the cover 26. The second member 36 includes an outer peripheral portion 50. The outer peripheral portion 50 is provided with a first pair of protrusions 54 and a second pair of protrusions 56. The first pair of protrusions 54 is formed diametrically opposite to the second pair of protrusions 56 on the outer peripheral portion 50. Each of the first pair of protrusions 54 is formed on either side of the first breakable tab 38. Similarly, each of the second pair of protrusions 56 is formed on either side of the second breakable tab 40.

The second member 36 is removably attached to the first member 34, via the first breakable tab 38 and the second breakable tab 40. The second member 36 conceals the access opening 44 of the first member 34, thereby covering the control switch 20 of the generator set 10. More specifically, the second member 36 conceals the access opening 44 in a mariner that a gap “G” is formed between the inner peripheral portion 42 of the first member 34 and the outer peripheral portion 50 of the second member 36.

The first and second breakable tabs 38, 40 are provided between the first member 34 and the second member 36, More specifically, the first and second breakable tabs 38, 40 are provided between the inner peripheral portion 42 of the first member 34 and the outer peripheral portion 50 of the second member 36. The first and second breakable tabs 38, 40 extend between the inner peripheral portion 42 and the outer peripheral portion 50, for connecting the first member 34 and the second member 36.

As shown in FIG. 2 and FIG. 3, the mounting member 28 has a rectangular shape. The mounting member 28 is coupled to the cover 26 and the housing member 16. More specifically, the mounting member 28 is fastened to the cover 26, and subsequently to the housing member 16, via the fastening members 32. The mounting member 28 is fastened to the cover 26 in a mariner that the second member 36 of the cover 26 is sandwiched between the housing member 16 and the mounting member 28.

The mounting member 28 includes a first inner peripheral portion 60 defining an opening 62. The mounting member 28 further includes a top end 64 and a bottom end 66. The mounting member 28 also includes a pair of flange portions 68, 70. The flange portions 68, 70 are disposed at the top end 64 and the bottom end 66 of the mounting member 28. More specifically, the flange portion 68 is disposed at the top end 64 of the mounting member 28, and similarly the flange portion 70 is disposed at the bottom end 66 of the mounting member 28.

The flange portions 68, 70 include a number of grooves, such as a first groove 72 and a second groove 74, disposed offset from a horizontal axis X-X′ (shown in FIG. 2) of the mounting member 28. More specifically, the flange portion 68 includes the first groove 72, and similarly the flange portion 70 includes the second groove 74. The first groove 72 and the second groove 74 are aligned with each other along a vertical axis Y-Y′. The tool 30 is removably supported on the mounting member 28. Specifically, the first groove 72 and the second groove 74 are provided to removably support the tool 30 on the mounting member 28 of the cover assembly 24. In an example, the tool 30 may be removably supported on any other location, such as the enclosure 12 of the generator set 10.

The tool 30, also refereed to as a “Pry tool”, includes an elongated handle portion 76, a first end 78, and a second end 80. The first end 78 includes a shoulder portion 82 and a pair of engagable portions, such as a first engagable portion 84 and a second engagable portion 86. In the illustrated example, the shoulder portion 82 abuts the flange portion 68, when the tool 30 is supported on the mounting member 28 through the first and second grooves 72, 74, thereby restricting a movement of the tool 30 in a downward direction along the vertical axis Y-Y′. The first engagable portion 84 and the second engagable portion 86 are selectively engagable with the first and second breakable tabs 38, 40. Each of the first and second engagable portions 84, 86 includes a pair of legs 88. Further, each of the first and second engagable portions 84, 86 includes a notch portion 89 disposed between the legs 88. The notch portion 89 is engagable with the first and second breakable tabs 38, 40.

The tool 30 is provided for breaking the first and second breakable tabs 38, 40, and subsequently detaching the first member 34 from the second member 36. The tool 30 is connected to the mounting member 28 by a cable assembly 75, also refereed to as a “lanyard”, fastened to the flange portion 70 of the mounting member 28 and the second end 80 of the tool 30. The cable assembly 75 ensures that the tool 30 remains connected to the mounting member 28, even when the tool 30 is removed from the first and second grooves 72, 74 of the mounting member 28.

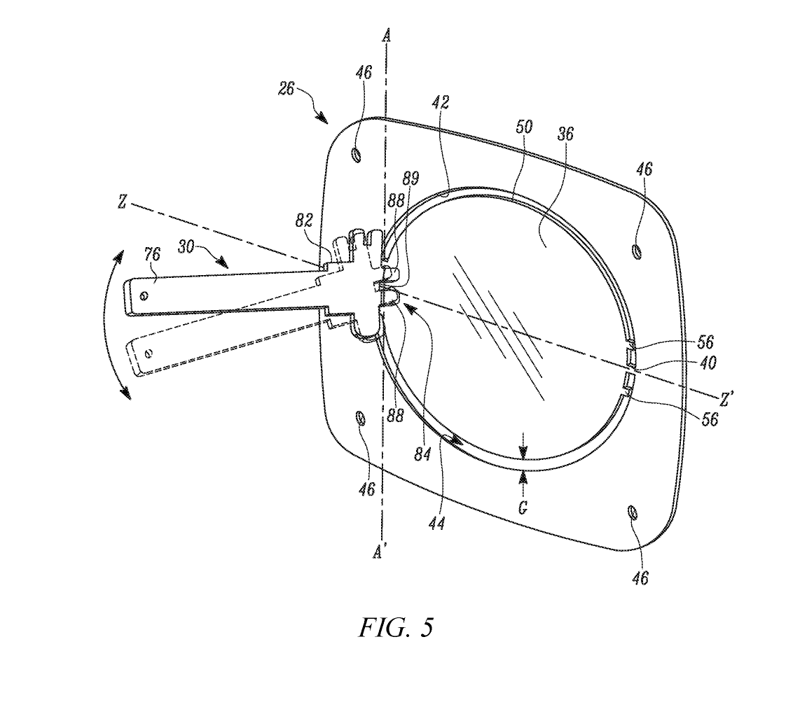

FIG. 5 illustrates a perspective view of the tool 30 engaged with the first breakable tab 38 of the cover 26. During emergency situations, the tool 30 is removed from the mounting member 28 by authorized personnel to selectively engage the first and second engagable portions 84, 86 with the first and second breakable tabs 38, 40. For the sake of brevity, the present disclosure will be described with regard to the first engagable portion 84 of the tool 30, although it will be understood that the present disclosure is also applicable to the second engagable portion 86 of the tool 30.

The first engagable portion 84 of the tool 30 is received within the gap “G” between the first member 34 and the second member 36 in a manner that the pair of legs 88 abuts the first pair of protrusions 54 and subsequently, the first breakable tab 38 is received within the notch portion 89. Afterwards, the tool 30 is moved to and fro in a predefined direction to break the first breakable tab 38 and subsequently, the first member 34 is removed from the cover 26 to access the control switch 20, The predefined direction herein refers to a direction of a movement of the tool 30 about a first axis Z-Z′. In one example, the predefined direction may be a direction of the movement of the tool 30 about a second axis A-A′ perpendicular to the first axis Z-Z′.

### INDUSTRIAL APPLICABILITY

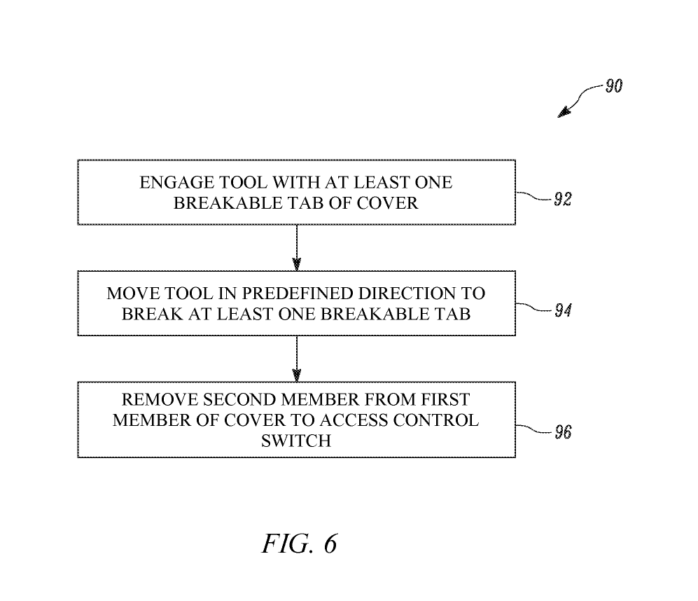

The present disclosure relates to the cover assembly 24 for the control switch 20 of the generator set 10. FIG. 6 is a flowchart depicting a method 90 of accessing the control switch 20 covered with the cover assembly 24, according to an embodiment of the present disclosure. For the sake of brevity, the aspects of the present disclosure which are already explained in detail in the description of FIG. 1, FIG. 2, FIG. 3, FIG. 4, and FIG. 5 are not explained in detail with regard to the description of the method 90.

At block 92, the method 90 includes engaging the tool 30 with the at least one breakable tab, such as the first breakable tab 38 and the second breakable tab 40, of the cover 26. The first engagable portion 84 is engaged with the first breakable tab 38 in a manner that the notch portion 89 of the first engagable portion 84 receives the first breakable tab 38. Similarly, the first engagable portion 84 is engaged with the second breakable tab 40 in a manner that the notch portion 89 of the first engagable portion 84 receives the second breakable tab 40.

At block 94, the method 90 includes moving the tool 30 in the predefined direction to break the at least one breakable tab, such as the first breakable tab 38 and the second breakable tab 40. More specifically, the tool 30 is moved in the predefined direction about the first axis Z-Z′, to break the first breakable tab 38 and the second breakable tab 40.

At block 96, the method 90 includes removing the second member 36 from the first member 34 of the cover 26 to access the control switch 20. When the second member 36 is removed from the first member 34, the authorized personnel access the control switch 20 through the access opening 44 of the cover 26.

The cover assembly 24 may be employed in any type of generator set, such as a diesel generator set, an electric generator set, and any other generator set known in the art. In an example, the cover assembly 24 can be employed in a building installation for covering emergency switches provided for switching-off various equipment installed in the building during emergency situations. Therefore, the cover assembly 24 has a wide range of application across industries.

The cover assembly 24 includes the cover 26 and the tool 30. The cover 26 is provided to cover the control switch 20 for protecting the control switch 20 from unauthorized access. The cover 26 includes the first member 34 and the second member 36. The first member 34 of the cover 26 is connected to the housing member 16 of the control switch 20 by fastening the fastening members 32. Owing to such connection of the cover 26 to the housing member 16, removal of the cover 26 for retrofitting becomes easy and simple. The second member 36 is connected to the first member 34, via the first and second breakable tabs 38, 40. When the first member 34 is connected to the housing member 16, the second member 36 covers the control switch 20. In order to obtain access to the control switch 20, the second member 36 is detached from the first member 34. Accordingly, the cover assembly 24 of the present disclosure provides a secure cover for the control switch 20. The second member 36 is detached from the first member 34 by breaking the first and second breakable tabs 38, 40. Since the first and second breakable tabs 38, 40 are broken to remove the second member 36; the cover assembly 24 also provides tampering evidence to the authorized personnel. The cover assembly 24 further provides the tool 30 to break the first and second breakable tabs 38, 40.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A cover for a control switch, the cover comprising:
a first member connected to a housing member of the control switch, the first member includes an inner peripheral portion;
a second member having an outer peripheral portion attached to the first member for concealing the control switch; and
at least one breakable tab extending between the inner peripheral portion of the first member and the outer peripheral portion of the second member for connecting the first member and the second member,
wherein the second member is adapted to be detached from the first member by breaking the at least one breakable tab to access the control switch.

2. The cover of claim 1, wherein the at least one breakable tab is adapted to be broken by a tool removably mounted on a mounting member connected to the cover and the housing member.

3. The cover of claim 2, wherein the tool includes at least one engagable portion adapted to selectively engage with the at least one breakable tab.

4. A cover assembly for a control switch, the cover assembly comprising:
a cover coupled to a housing member of the control switch, the cover including:
a first member connected to a housing member of the control switch, the first member includes an inner peripheral portion;
a second member having an outer peripheral portion attached to the first member for concealing the control switch; and
at least one breakable tab extending between the inner peripheral portion of the first member and the outer peripheral portion of the second member for connecting the first member and the second member;
a mounting member coupled to the first member and the housing member; and
a tool removably supported on the mounting member, wherein the tool includes at least one engagable portion adapted to selectively engage with the at least one breakable tab,
wherein the second member is adapted to detach from the first member by breaking the at least one breakable tab using the tool to access the control switch.
